(19) United States
(12) Patent Application Publication
(10) Pub. No.: US 2014/0292600 A1
(43) Pub. Date: Oct. 2, 2014

(54) ANTENNA AND WIRELESS COMMUNICATION APPARATUS

(71) Applicant: FUJITSU LIMITED, Kawasaki-shi (JP)

(72) Inventors: Katsumi SAKUMA, Kawasaki (JP); Shusaku YOSHIDA, Sendai (JP); Yutaka ODA, Sapporo (JP)

(73) Assignee: FUJITSU LIMITED, Kawasaki-shi (JP)

(21) Appl. No.: 14/209,373

(22) Filed: Mar. 13, 2014

(30) Foreign Application Priority Data
Mar. 29, 2013 (JP) 2013-075083

(51) Int. Cl. H01Q 1/36

(52) U.S. Cl. CPC H01Q 1/36
USPC 343/749

(57) ABSTRACT

An antenna includes a first layer including a pattern so as to configure an inductor, a second layer forming capacitance that is electrically coupled with inductance of the inductor, and a third layer configuring an electric wall, the first layer being disposed between the third layer and the first layer.

### CROSS-REFERENCE TO RELATED APPLICATION

This application is based upon and claims the benefit of priority of the prior Japanese Patent Application No. 2013-075083, filed on Mar. 29, 2013, the entire contents of which are incorporated herein by reference.

### FIELD

The embodiment discussed herein is related to an antenna and a wireless communication apparatus.

### BACKGROUND

In general wireless communication apparatuses, an antenna is disposed away from the ground so that influence of the ground on the antenna is reduced. Furthermore, a technique has been widely used in which a magnetic wall for absorbing electromagnetic waves is disposed between the ground and an antenna (refer to Japanese Laid-open Patent Publication No. 2011-55054, for example). Furthermore, a technique has been widely used in which reduction of electromagnetic interference between antennas and between devices implemented on a printed circuit board is achieved by forming an electromagnetic bandgap structure which suppresses propagation of electromagnetic waves in a specific frequency band (refer to International Publication Pamphlet No. WO 2010/013496, for example).

Moreover, a metamaterial has been widely known which is composed by arranging material pieces at intervals smaller than a wavelength of electromagnetic waves to obtain an electric characteristic and a magnetic characteristic different from those of the original material pieces. In addition, a technique has been known which forms a magnetic wall by a metamaterial in which a plurality of mushroom-shaped structures, in which a ground and conductors are connected to each other by vias, are periodically arranged (refer to SANADA Atsushi, Tutorial “What is Metamaterials”, November 17 issue of Nikkei Electronics, pp. 128 to 134, Japan, 2008, SANADA Atsushi, Tutorial “What is Metamaterials”, December 15 issue of Nikkei Electronics, pp. 159 to 169, Japan, 2008, SANADA Atsushi, Tutorial “What is Metamaterials”, January 12 issue of Nikkei Electronics, pp. 104 to 111, Japan, 2009, and SANADA Atsushi, Tutorial “What is Metamaterials”, February 9 issue of Nikkei Electronics, pp. 110 to 116, Japan, 2009, for example). Furthermore, a technique of applying a metamaterial to antennas has been widely used (refer to NAKANO Hisamatsu, “Applications of Metamaterials to Antennas”, The 2006 IEICE General Conference, BT-1-2, pp. SS40 to SS41, for example). Moreover, various results of simulations of metamaterials have been reported (refer to MATSUNAGA Naoko et al., “On a Novel Two-Dimensional Planer Distributed Structure with Negative Refractive Index”, The 2005 IEICE General Conference, CS-2-3, pp. S22 to S23, Japan, D. R. Smith et al., “Electromagnetic Parameter Retrieval from Inhomogeneous Metamaterials”, Physical Review E71, pp. 036617-1 to 036617-11, USA, 2005, and KATAYAMA Naoki et al., “Estimation for Material Parameters of Metamaterial by Using Complex Chart Procedure”, Proceedings of IEEE Hiroshima Student Symposium, Vol. 10, pp. 86 to 89, Japan, 2008, for example).

### SUMMARY

According to an aspect of the invention, an antenna includes a first layer including a pattern so as to configure an inductor, a second layer forming capacitance that is electrically coupled with inductance of the inductor; and a third layer configuring an electric wall, the first layer being disposed between the third layer and the first layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first example of an antenna according to an embodiment;

FIG. 2 is a diagram illustrating layers of the antenna of FIG. 1;

FIG. 3 is a sectional view schematically illustrating the antenna of FIG. 1;

FIG. 4 is a diagram illustrating another pattern of an inductor of the antenna according to the embodiment;

FIG. 5 is a diagram illustrating an equivalent circuit of the antenna of FIG. 1;

FIG. 6 is a diagram illustrating layers of the antenna in a second example according to the embodiment;

FIG. 7 is a sectional view schematically illustrating the antenna of FIG. 6;

FIG. 8 is a diagram illustrating an equivalent circuit of the antenna of FIG. 6;

FIG. 9 is a diagram illustrating a mushroom structure of an electromagnetic wall including structures having a mushroom shape arranged therein;

FIG. 10 is a sectional view schematically illustrating an antenna having the mushroom structure of FIG. 9;

FIG. 11 is a diagram illustrating an example of an analysis model used in a simulation;

FIG. 12 is a diagram illustrating an example of a unit cell of the analysis model of FIG. 11;

FIG. 13 is a characteristic diagram illustrating results of the simulation;

FIG. 14 is a diagram illustrating an example of a wireless communication apparatus according to the embodiment;

FIG. 15 is a diagram illustrating an example of arrangement of antennas in the wireless communication apparatus of FIG. 14;

FIG. 16 is a diagram illustrating the example of the arrangement of the antennas of FIG. 14 viewed from a side;

FIG. 17 is a diagram illustrating an example of arrangement of antennas when the antennas of the embodiment are not used; and

FIG. 18 is a diagram illustrating the example of the arrangement of the antennas of FIG. 17 viewed from a side.

### DESCRIPTION OF EMBODIMENTS

However, there arises a problem in that, since an antenna is disposed away from the ground in conventional wireless communication apparatuses, it is difficult to obtain thin wireless communication apparatuses. Furthermore, there arises a problem in that, since an inductor is configured using via holes in a magnetic wall including structures having a mushroom shape, the via holes having a certain length or more inhibits wireless communication apparatuses to be made thinner. Accordingly it is desired to provide an antenna which will serve in reduction of thickness of a wireless communication device and a low-profile wireless communication device.

An embodiment of an antenna and a wireless communication apparatus will be described in detail hereinafter with reference to the accompanying drawings. In a description of the embodiment below, the same components are denoted by the same reference numerals and redundant descriptions thereof are omitted.

### First Example of Antenna

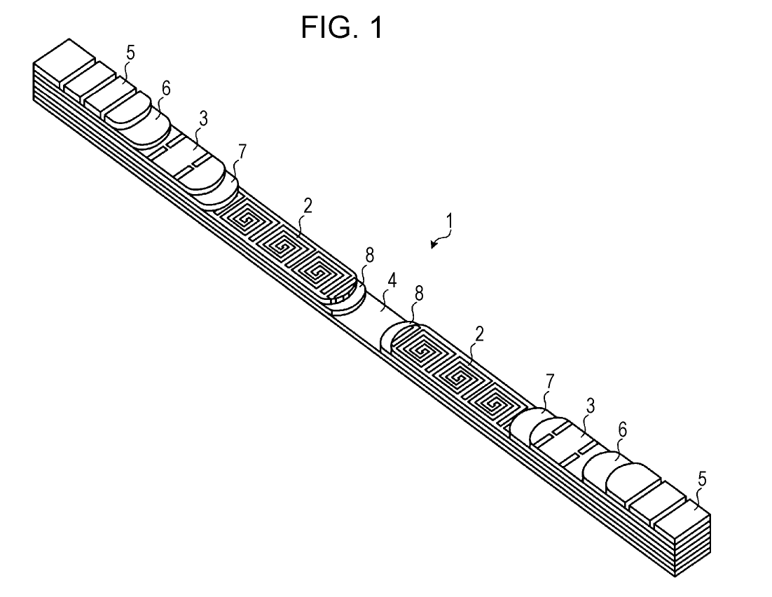

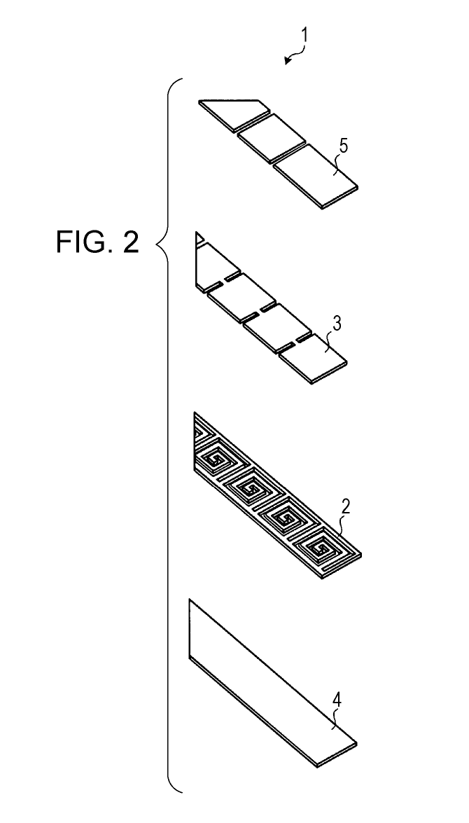

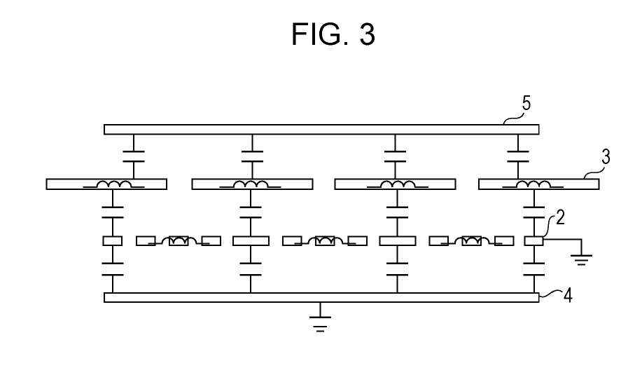

FIG. 1 is a diagram illustrating a first example of an antenna according to an embodiment. FIG. 2 is a diagram illustrating each layer in the antenna in FIG. 1. FIG. 3 is a sectional view schematically illustrating the antenna of FIG. 1. In FIGS. 2 and 3, dielectric layers interposed between conductive layers are omitted.

As illustrated in FIGS. 1 to 3, an antenna 1 includes a first layer 2 including a pattern serving as an inductor, a second layer 3 which is used to hold capacitance between the second layer 3 and inductance of the inductor, and a third layer 4 constituting an electric wall. The antenna 1 further includes an antenna conductive layer 5 formed by a conductor on an uppermost surface, for example.

For example, a first dielectric layer 6 formed by a dielectric body is disposed beneath the antenna conductive layer 5 so as to be contact with the antenna conductive layer 5. For example, the second layer 3 formed by a conductive body is disposed beneath the first dielectric layer 6 so as to be contact with the first dielectric layer 6. Furthermore, for example, a second dielectric layer 7 formed by a dielectric body is disposed beneath the second layer 3 so as to be contact with the second layer 3.

For example, the first layer 2 formed by a conductive body is disposed beneath the second dielectric layer 7 so as to be contact with the second dielectric layer 7. Furthermore, for example, a third dielectric layer 8 formed by a dielectric body is disposed beneath the first layer 2 so as to be contact with the first layer 2. For example, the third layer 4 formed by a conductive body is disposed beneath the third dielectric layer 8 so as to be contact with the third dielectric layer 8.

Specifically, the antenna 1 is configured by laminating the third layer 4, the third dielectric layer 8, the first layer 2, the second dielectric layer 7, the second layer 3, the first dielectric layer 6, and the antenna conductive layer 5 in this order from the bottom. Note that the first dielectric layer 6, the second dielectric layer 7, and the third dielectric layer 8 may be air layers.

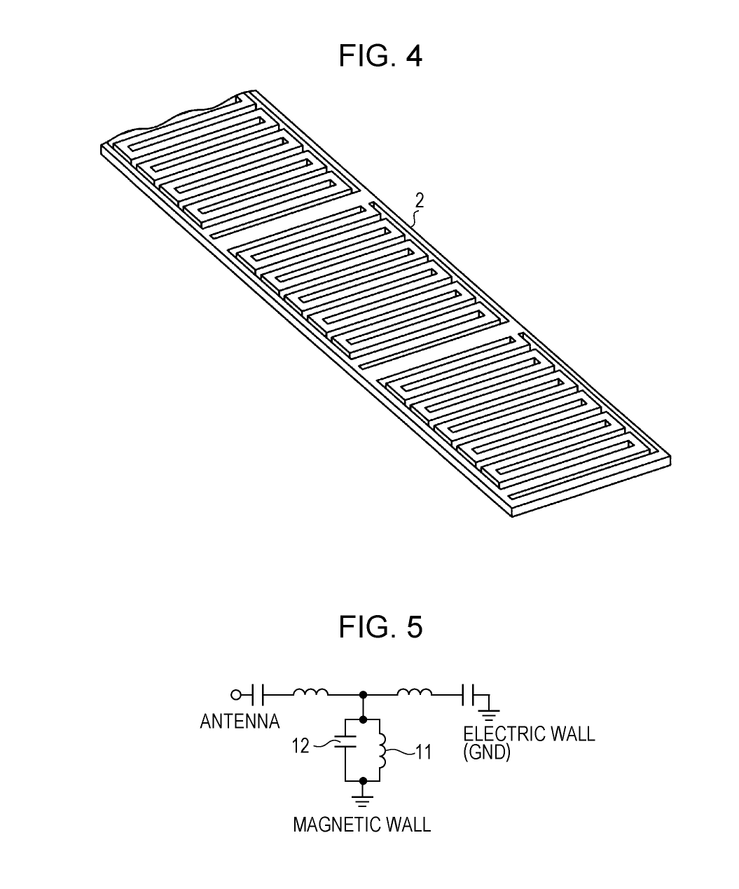

In the first layer 2, the inductor includes a structure such that a plurality of unit elements smaller than a wavelength of electromagnetic wave are arranged, and is formed by a left-handed metamaterial which has negative permittivity and negative permeability, where the electromagnetic wave is preferably corresponding to one used for a wireless radio frequency for example. The number of unit elements is determined in accordance with a frequency of the electromagnetic waves. Each of the unit elements included in the inductor may have a wiring pattern of a spiral shape, for example. Alternatively, each of the unit elements included in the inductor may have a wiring pattern of a meander shape, for example, as illustrated in FIG. 4 which is a diagram illustrating the alternative pattern of the inductor of the antenna according to the embodiment.

As illustrated in FIG. 3, capacitance is generated between the third layer 4 and the first layer 2, between the first layer 2 and the second layer 3, and between the second layer 3 and the antenna conductive layer 5. As illustrated in FIG. 3, for example, the third layer 4 and one end of the first layer 2 may be set to the ground potential. The first layer 2 and the second layer 3 form a magnetic wall by inductance generated by the first layer 2 and the capacitance generated between the first layer 2 and the second layer 3.

FIG. 5 is a diagram illustrating an equivalent circuit of the antenna 1 of FIG. 1. As illustrated in FIG. 5, the electric wall is formed by a conductive layer functioning as a ground potential GND, for example, beneath an antenna conductive layer. The magnetic wall is formed by an inductor 11 and a capacitance 12 which are coupled to each other in parallel, where one end of the inductor 11 and one end of the capacitance 12 are set to the ground potential, for example. The magnetic wall has a characteristic in which permittivity and permeability are both negative values.

### Second Example of Antenna

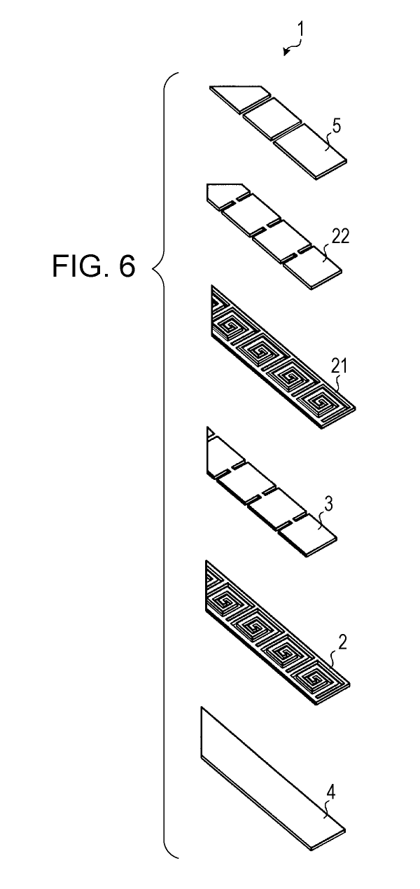

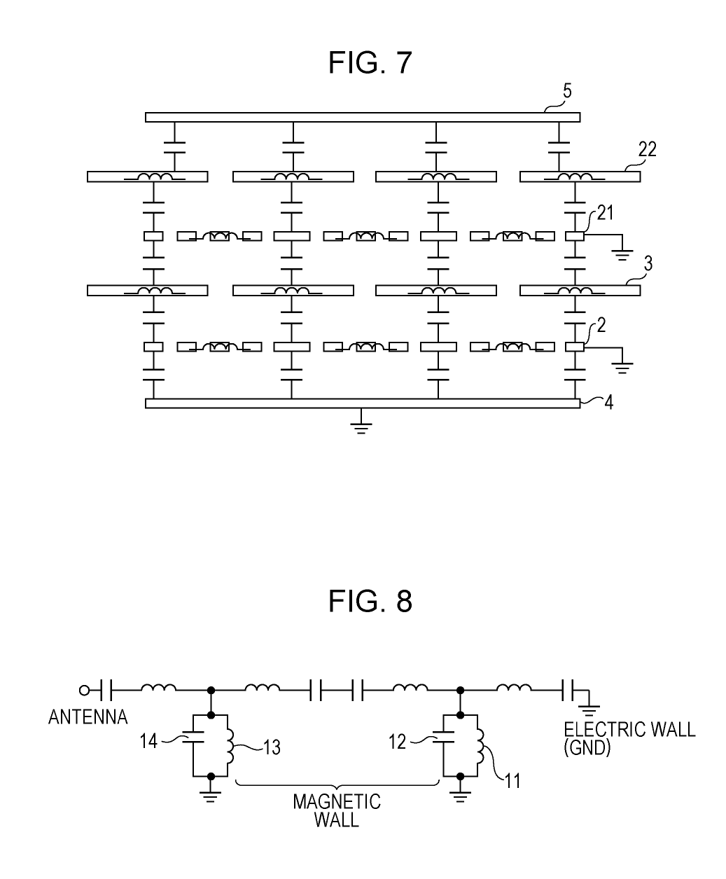

FIG. 6 is a diagram illustrating layers of an antenna in a second example according to the embodiment, in which each of the layers are depicted separately. FIG. 7 is a sectional view schematically illustrating the antenna of FIG. 6. In FIGS. 6 and 7, dielectric layers interposed between conductive layers are omitted.

As illustrated in FIGS. 6 and 7, the antenna 1 includes a first layer 2 including a pattern for an inductor, a second layer 3 which is used to hold capacitance between the second layer 3 and inductance of the inductor, and a third layer 4 constituting an electric wall. The antenna 1 further includes a fourth layer 21 including a pattern for an inductor and a fifth layer 22 which is used to hold capacitance between the fifth layer 22 and inductance of the inductor of the fourth layer 21. The antenna 1 further includes an antenna conductive layer 5 formed by a conductor on an uppermost surface thereof, for example.

For example, a first dielectric layer formed by a dielectric body, not illustrated, is disposed beneath the antenna conductive layer 5 so as to be contact with the antenna conductive layer 5. For example, the fifth layer 22 is formed of a conductive body and disposed beneath the first dielectric layer, not illustrated, so as to be contact with the first dielectric layer. For example, a fourth dielectric layer formed by a dielectric body, not illustrated, is disposed beneath the fifth layer 22 so as to be contact with the fifth layer 22.

For example, the fourth layer 21 is formed of a conductive body and disposed beneath the fourth dielectric layer, not illustrated, so as to be contact with the fourth dielectric layer. Furthermore, for example, a fifth dielectric layer is formed of a dielectric body, not illustrated, and disposed beneath the fourth layer 21 so as to be contact with the fourth layer 21. For example, the second layer 3 is formed of a conductive body and disposed beneath the fifth dielectric layer, not illustrated, so as to be contact with the fifth dielectric layer. Furthermore, for example, a second dielectric layer is formed of a dielectric body, not illustrated, and disposed beneath the second layer 3 so as to be contact with the second layer 3.

For example, the first layer 2 is formed of a conductive body and disposed beneath the second dielectric layer, not illustrated, so as to be contact with the second dielectric layer. Furthermore, for example, a third dielectric layer is formed of a dielectric body, not illustrated, and disposed beneath the first layer 2 so as to be contact with the first layer 2. For example, the third layer 4 is formed of a conductive body and disposed beneath the third dielectric layer, not illustrated, so as to be contact with the third dielectric layer.

Specifically, the antenna 1 is configured by laminating the third layer 4, the third dielectric layer, the first layer 2, the second dielectric layer, the second layer 3, the fifth dielectric layer, the fourth layer 21, the fourth dielectric layer, the fifth layer 22, the first dielectric layer, and the antenna conductive layer 5 in this order from the bottom. Here, the dielectric layers may be air layers.

In the first layer 2 and the fourth layer 21, the inductor is formed by a left-handed metamaterial which is configured such that a plurality of unit elements smaller than a wavelength of electromagnetic wave are arranged and which has negative permittivity and negative permeability, where the electromagnetic wave is preferably corresponding to one used for a wireless radio frequency. The unit elements included in the inductor may include a wiring pattern of a spiral shape, for example. Alternatively, the unit elements of the inductor may include a wiring pattern of a meander shape, for example, as illustrated in FIG. 4.

As illustrated in FIG. 7, each capacitance is generated respectively between the third layer 4 and the first layer 2, between the first layer 2 and the second layer 3, between the second layer 3 and the fourth layer 21, between the fourth layer 21 and the fifth layer 22, and between the fifth layer 22 and the antenna conductive layer 5. As illustrated in FIG. 7, for example, the third layer 4, one end of the first layer 2, and one end of the fourth layer 21 may include the ground potential.

The first layer 2 and the second layer 3 form a magnetic wall by inductance generated by the first layer 2 and the capacitance generated between the first layer 2 and the second layer 3. The fourth layer 21 and the fifth layer 22 form a magnetic wall by inductance generated by the fourth layer 21 and the capacitance generated between the fourth layer 21 and the fifth layer 22.

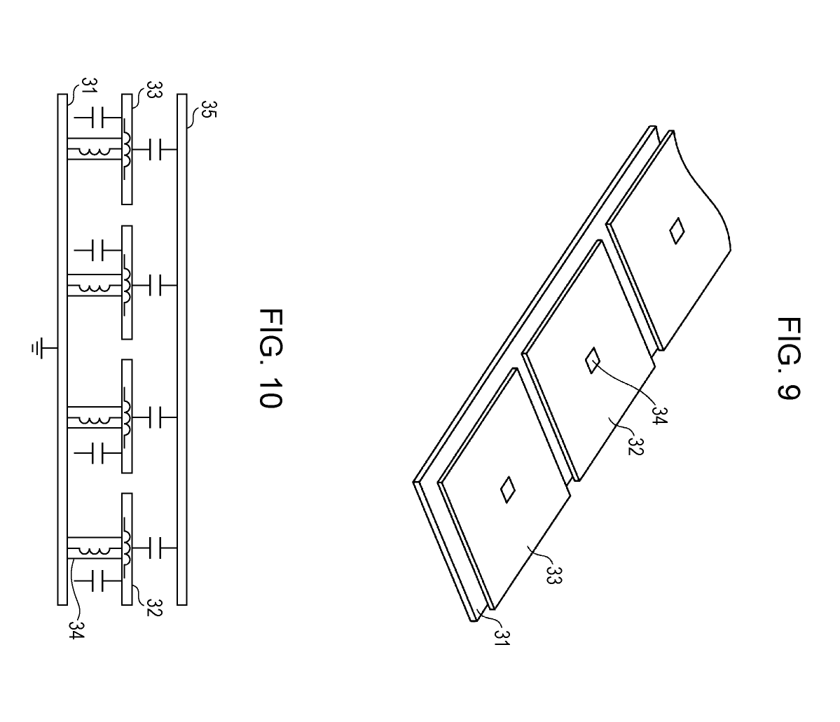

FIG. 8 is a diagram illustrating an equivalent circuit of the antenna 1 of FIG. 6. As illustrated in FIG. 8, the electric wall is formed by a conductive layer having a ground potential GND, for example, under an antenna conductive layer. The magnetic walls are formed by an inductor 11 and a capacitance 12 which are connected to each other in parallel and an inductor 13 and a capacitance 14 which are connected to each other in parallel. One end of the inductor 11, one end of the capacitance 12, one end of the inductor 13, and one end of the capacitance 14 have the ground potential, for example.

The magnetic walls have a characteristic in which permittivity and permeability are both negative values. It is preferable for the antenna 1 to include further a similar magnetic wall which includes a layer including a pattern for an inductor and an additional layer which is used to hold capacitance between the additional layer and inductance of the inductor. The antenna 1 illustrated in FIG. 1 and FIG. 6 may be fabricated using a technique of fabricating a multilayer printed circuit board. Fabricating the antenna 1 using the technique of fabricating a multilayer printed circuit board, the thickness of the antenna 1 may be formed so as having a thickness corresponding to the multilayer printed circuit board.

It will be described hereinafter on “an electromagnetic wall including a structure of a mushroom shape and an antenna.” FIG. 9 is a diagram illustrating a mushroom structure as an electromagnetic wall including mushroom shape elements structures being arranged. In FIG. 9, dielectric layers interposed between conductive layers are not illustrated.

As illustrated in FIG. 9, the electromagnetic wall includes the mushroom structure, where the mushroom structure includes a second conductive layer 33 which is disposed on the first conductive layer 31 across a dielectric layer (not illustrated). In the second conductive layer 33, unit elements referred to as lands 32 are arranged. A length of each side of the lands 32 is smaller than a wavelength of electromagnetic wave to be used for wireless radio communication.

The lands 32 and the first conductive layer 31 are electrically coupled to each other through via holes 34 which penetrate the dielectric layer, not illustrated, disposed between the second conductive layer 33 and the first conductive layer 31. An electric wall is formed by the first conductive layer 31. A magnetic wall is formed by capacitance generated between the lands 32 and the first conductive layer 31 and the via holes 34.

FIG. 10 is a sectional view schematically illustrating the antenna including the mushroom structure of FIG. 9. In FIG. 10, the dielectric layers interposed between the conductive layers are omitted. As illustrated in FIG. 10, the electromagnetic wall illustrated in FIG. 9 is disposed under an antenna conductive layer 35 such that a dielectric layer, not illustrated, is interposed between the antenna conductive layer 35 and the electromagnetic wall. Capacitance is generated between the antenna conductive layer 35 and the lands 32.

### Comparison of Complex Reflection Coefficients S11 by Simulation

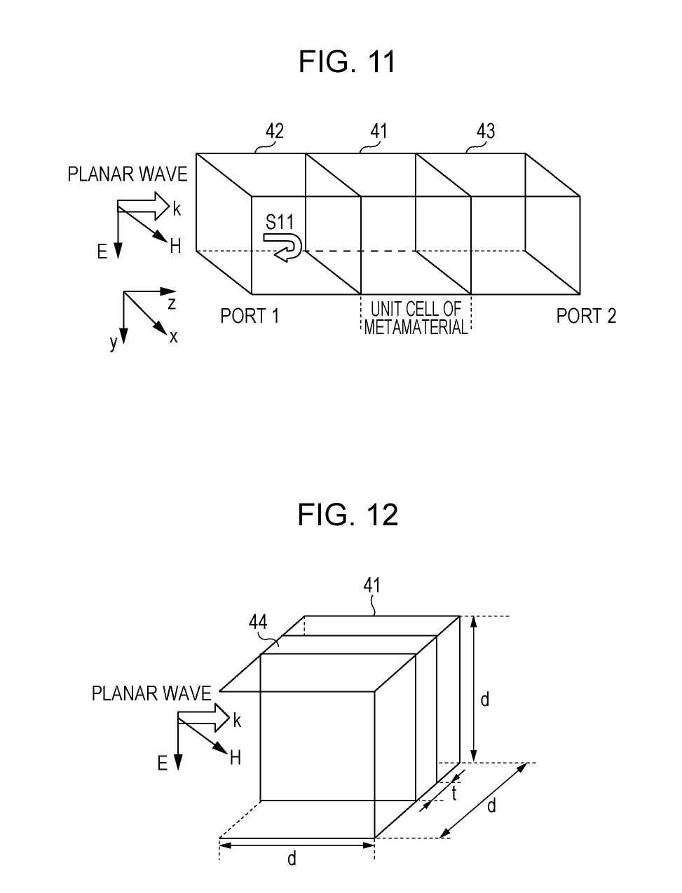

FIG. 11 is a diagram illustrating an example of an analysis model used in simulation. As illustrated in FIG. 11, a complex reflection coefficient S11 is observed in a state in which free space regions 42 and 43 are formed so that a unit cell 41 of a metamaterial is sandwiched therebetween and a planar wave is irradiated from a port 1 to the unit cell 41 of the metamaterial.

Here, when a planar wave having an electric field E and a magnetic field H is used as an incident wave, it is assumed that the unit cell 41 is periodically and infinitely expanded in an xy plane using upper and lower surfaces of the analysis model as electric walls and left and right surfaces as magnetic walls. Here, “k” denotes a traveling direction of the planar wave.

FIG. 12 is a diagram illustrating an example of the unit cell 41 of the analysis model of FIG. 11. It is assumed that a length of sides of a cube of the unit cell 41 of the metamaterial is denoted by d and a width of a component 44 included in the unit cell 41 is denoted by t as illustrated in FIG. 12. For example, d may be 2.5 mm and t may be 0.25 mm. The analysis model illustrated in FIG. 11 and the unit cell illustrated in FIG. 12 are disclosed in KATAYAMA Naoki et al., “Estimation for Material Parameters of Metamaterial by Using Complex Chart Procedure”, Proceedings of IEEE Hiroshima Student Symposium, Vol. 10, pp. 86 to 89, Japan, 2008.

A first example of this simulation corresponds to a case where, in the structures of the electric wall and the magnetic walls of the antenna 1 illustrated in FIG. 6, a single unit element of an inductor including a spiral wiring pattern corresponds to the component 44 in the unit cell 41. A second example corresponds to a case where, in the structures of the electric wall and the magnetic walls of the antenna 1 illustrated in FIG. 6, a single unit element of an inductor including a meander wiring pattern corresponds to the component 44 in the unit cell 41. A comparative example corresponds to a case where, in the electromagnetic wall of the mushroom shape illustrated in FIG. 9, a single land corresponds to the component 44 included in the unit cell 41.

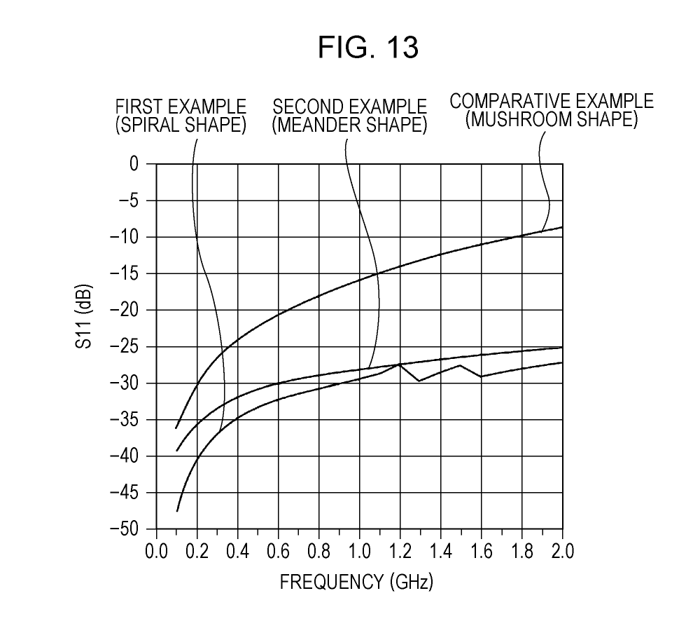

FIG. 13 is a characteristic diagram illustrating results of the simulation. In FIG. 13, a vertical axis denotes the complex reflection coefficient S11 and a unit thereof is dB. An horizontal axis denotes a frequency and a unit thereof is GHz. According to FIG. 13, it is apparent in a frequency range from 0.1 to 2.0 GHz that a complex reflection coefficient S11 of the first example corresponding to the spiral shape and a complex reflection coefficient S11 of the second example corresponding to the meander shape are both smaller than a complex reflection coefficient S11 of the comparative example corresponding to the mushroom shape. Specifically, reflection in the component 44 of the unit cell 41 in the first example corresponding to the spiral shape and reflection in the component 44 of the unit cell 41 in the second example corresponding to the meander shape are both smaller than reflection in the component 44 of the unit cell 41 in the comparative example corresponding to the mushroom shape.

According to the antenna 1 of FIG. 1, the inductance and the capacitance may be held between the first layer 2 and the second layer 3. Furthermore, according to the antenna 1 of FIG. 6, the inductance and the capacitance may be held between the first layer 2 and the second layer 3, and in addition, the inductance and the capacitance may be held by the fourth layer 21 and the fifth layer 22. Therefore, the via holes 34 used in the mushroom structure may be omitted. Accordingly, a thin wireless communication apparatus including the antenna 1 of FIG. 1 or FIG. 6 implemented therein may be achieved.

According to the antenna 1 of FIG. 1 or FIG. 6, return of a signal which has been transmitted from the antenna 1 in a state of a reversed phase may be suppressed. Furthermore, since influence of other antennas, wireless circuits, and the ground may be suppressed by the electric wall, the antenna 1 may not be disposed away from the ground. Accordingly, a thin wireless communication apparatus including the antenna 1 of FIG. 1 or FIG. 6 implemented therein may be achieved.

When the electromagnetic wall including the mushroom structure is to be used, a large number of small via holes 34 are formed at small intervals, and therefore, fabrication cost is increased. On the other hand, according to the antenna 1 of FIG. 1 or FIG. 6, the via holes 34 of the mushroom structure are not used, and therefore, increase of the fabrication cost may be suppressed.

### Example of Wireless Communication Apparatus

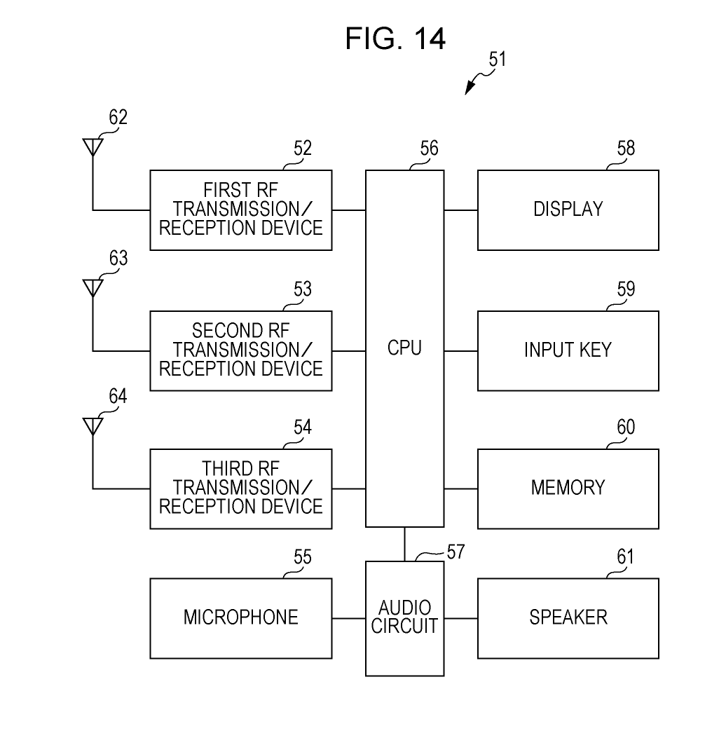

FIG. 14 is a diagram illustrating an example of the wireless communication apparatus according to the embodiment. Cellular phones and smart phones are examples of the wireless communication apparatus. In this embodiment, it is assumed that the wireless communication apparatus corresponds to a cellular phone or a smart phone. However, the wireless communication apparatus of this embodiment is applicable to wireless communication apparatuses other than cellular phones and smart phones.

For example, as illustrated in FIG. 14, a wireless communication apparatus 51 includes a first radio frequency (RF) transmission/reception device 52, a second RF transmission/reception device 53, and a third RF transmission/reception device 54. The number of the FR transmission/reception devices may be one, two, four, or more. The wireless communication apparatus 51 includes a microphone 55, a central processing unit (CPU) 56, an audio circuit 57, a display 58, an input key 59, a memory 60, and a speaker 61.

The first RF transmission/reception device 52 is coupled to an antenna 62 and the CPU 56. The antenna 62 may be the antenna 1 illustrated in FIG. 1 or FIG. 6. The first RF transmission/reception device 52 receives a wireless signal from a mobile telephone network through the antenna 62, for example, generates reception data from the received signal, and transmits the reception data to the CPU 56. The first RF transmission/reception device 52 generates a transmission signal from transmission data supplied from the CPU 56 and transmits the transmission signal to the mobile telephone network through the antenna 62, for example.

The second RF transmission/reception device 53 is connected to an antenna 63 and the CPU 56. The antenna 63 may be the antenna 1 illustrated in FIG. 1 or FIG. 6. The second RF transmission/reception device 53 receives a wireless signal from a wireless local area network (LAN) through the antenna 63, for example, generates reception data from the received signal, and transmits the reception data to the CPU 56. The second RF transmission/reception device 53 generates a transmission signal from transmission data supplied from the CPU 56 and transmits the transmission signal to the wireless LAN through the antenna 63, for example.

The third RF transmission/reception device 54 is coupled to an antenna 64 and the CPU 56. The antenna 64 may be the antenna 1 illustrated in FIG. 1 or FIG. 6. The third RF transmission/reception device 54 receives a wireless signal from a near field communication (NFC) network through the antenna 64, for example, generates reception data from the received signal, and transmits the reception data to the CPU 56. The third RF transmission/reception device 54 generates a transmission signal from transmission data supplied from the CPU 56 and transmits the transmission signal to the NFC network through the antenna 64, for example.

Here, the wireless communication apparatus 51 may include an antenna and an RF reception device which receive electromagnetic waves of frequencies used for wireless chargers, digital terrestrial broadcasting, satellite broadcasting, or a global positioning system (GPS). The wireless communication apparatus 51 may include an antenna and an RF transmission/reception device which transmit and receive electromagnetic waves of frequencies used for FM transmitters and the Bluetooth (registered trademark).

The display 58 is coupled to the CPU 56. The display 58 displays text and images in accordance with data output from the CPU 56. A touch panel may be disposed on a surface of the display 58 so that characters and symbols are input using the touch panel.

The input key 59 is coupled to the CPU 56. The input key 59 is used to input characters and symbols to the CPU 56.

The memory 60 is coupled to the CPU 56. The memory 60 stores programs of an operating system (OS) and various applications which are to be executed by the CPU 56. The memory 60 is used as a working area of the CPU 56.

The speaker 61 is coupled to the audio circuit 57. The speaker 61 outputs audio in accordance with a signal output from the audio circuit 57.

The microphone 55 is coupled to the audio circuit 57. The microphone 55 is used to input an audio signal to the audio circuit 57.

The audio circuit 57 is coupled to the CPU 56. The audio circuit 57 generates audio data from an audio signal supplied from the microphone 55 and transmits the audio data to the CPU 56. Furthermore, the audio circuit 57 generates an audio signal from audio data supplied from the CPU 56 and transmits the audio signal to the speaker 61.

The CPU 56 executes the programs of the operating system and the various applications. The CPU 56 processes data input from the first RF transmission/reception device 52, the second RF transmission/reception device 53, the third RF transmission/reception device 54, the input key 59, the memory 60, and the audio circuit 57. The CPU 56 outputs processed data to the first RF transmission/reception device 52, the second RF transmission/reception device 53, the third RF transmission/reception device 54, the display 58, the memory 60, and the audio circuit 57.

The CPU 56 controls entire operation of the wireless communication apparatus 51. The wireless communication apparatus 51 may include a CPU used for wireless communication and a CPU used to execute application programs.

### Example of Arrangement of Antennas in Wireless Communication Apparatus

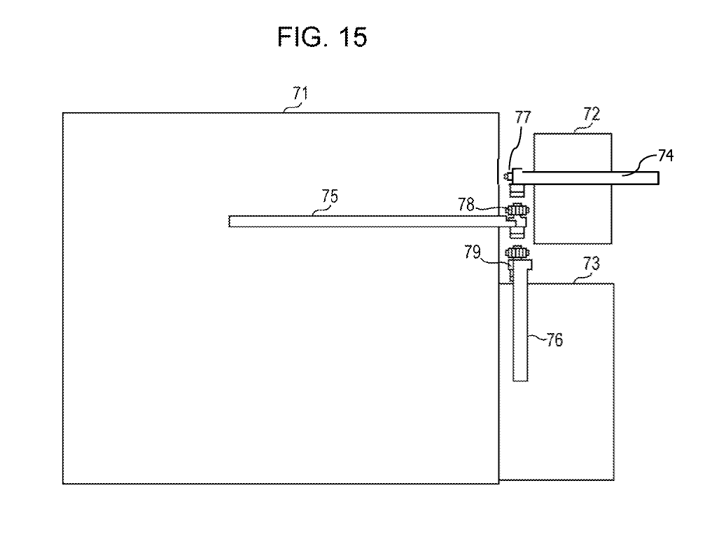

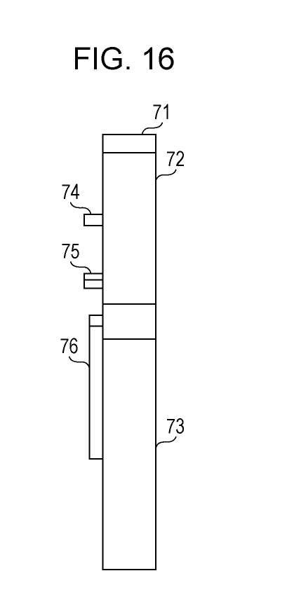

FIG. 15 is a diagram illustrating arrangement of the antennas in the wireless communication apparatus 51 of FIG. 14. FIG. 16 is a diagram illustrating the example of the arrangement of the antennas of FIG. 14 viewed from a side.

As illustrated in FIGS. 15 and 16, when antennas 74, 75, and 76 correspond to the antenna 1 illustrated in FIG. 1 or FIG. 6, the antennas 74, 75, and 76 may be linearly implemented on plates 71, 72, and 73 having the ground potential so as not to be away from the plates 71, 72, and 73. In FIG. 15, reference numerals 77, 78, and 79 denote contact springs for the antennas 74, 75, and 76.

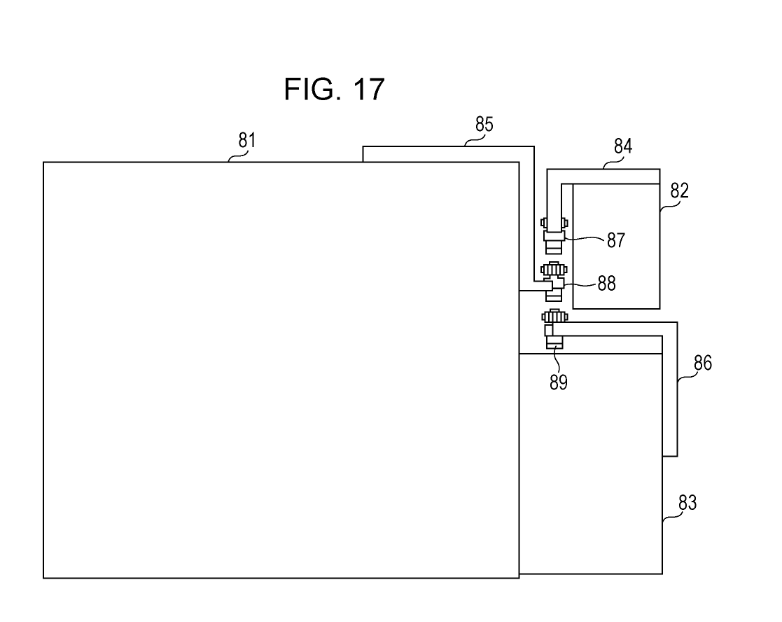

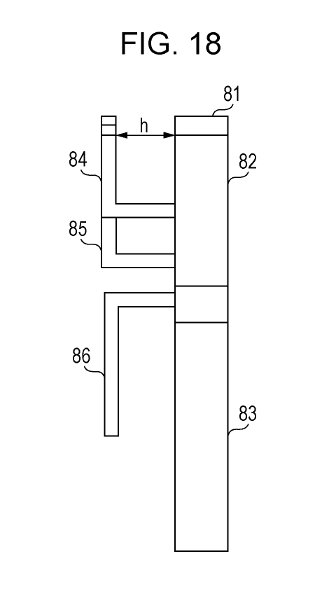

FIG. 17 is a diagram illustrating an example of arrangement of antennas when the antennas of the embodiment are not used. FIG. 18 is a diagram illustrating an example of the arrangement of the antennas of FIG. 17 viewed from a side.

As illustrated in FIGS. 17 and 18, when antennas 84, 85, and 86 do not correspond to the antenna 1 illustrated in FIG. 1 or FIG. 6, the antennas 84, 85, and 86 are implemented so as not to be arranged on plates 81, 82, and 83 and bypass the plates 81, 82, and 83. Furthermore, the antennas 84, 85, and 86 are implemented so as to be away from the plates 81, 82, and 83 having the ground potential.

For example, the antennas 84, 85, and 86 are implemented so as to be away from the plates 81, 82, and 83 having the ground potential by a distance h. The distance h is equal to or larger than 1 mm, for example. In FIG. 17, reference numerals 87, 88, and 89 denote contact springs for the antennas 84, 85, and 86.

According to the wireless communication apparatus 51 corresponding to the antenna arrangement example illustrated in FIGS. 15 and 16, since each of the antennas 74, 75, and 76 has an electric wall and a magnetic wall, the antennas 74, 75, and 76 may be linearly implemented on the plates 71, 72, and 73 so as not to be away from the plates 71, 72, and 73. Therefore, a dead space to be used by the antennas 74, 75, and 76 for bypassing the plates 71, 72, and 73 is not provided and a space for separating the antennas 74, 75, and 76 from the plates 71, 72, and 73 is not provided. Accordingly, the small and thin wireless communication apparatus 51 may be obtained.

According to the wireless communication apparatus 51 corresponding to the antenna arrangement example illustrated in FIGS. 15 and 16, a thickness of the wireless communication apparatus 51 may be reduced by 1 mm or more, for example, when compared with the wireless communication apparatus corresponding to the antenna arrangement example illustrated in FIGS. 17 and 18.

Furthermore, use of the antenna 1 illustrated in FIG. 1 or FIG. 6 may omit the via holes included in the mushroom structure. Accordingly, a thinner wireless communication apparatus may be obtained when compared with the case where the antenna having the electromagnetic wall having the mushroom structure is used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An antenna comprising:
a first layer including a pattern so as to configure an inductor;
a second layer forming capacitance that is electrically coupled with inductance of the inductor; and
a third layer configuring an electric wall, the first layer being disposed between the third layer and the first layer.

2. The antenna according to claim 1, wherein
the inductor includes a structure including a plurality of unit elements smaller than a certain wavelength of electromagnetic waves, the inductor being formed by a left-handed metamaterial, permittivity and permeability of the left-handed metamaterial being negative.

3. The antenna according to claim 1, further comprising:
a fourth layer including a pattern for configuring an inductor; and
a fifth layer that is used to hold capacitance between the fifth layer and inductance of the inductor of the fourth layer.

4. The antenna according to claim 3, wherein
the inductor of the fourth layer includes a structure including a plurality of unit elements smaller than a certain wavelength of electromagnetic waves, the inductor of the fourth layer being formed by a left-handed metamaterial, permittivity and permeability of the left-handed metamaterial being negative.

5. The antenna according to claim 2, wherein
each of the plurality of unit elements includes a wiring pattern of a spiral shape.

6. The antenna according to claim 2, wherein
each of the plurality of unit elements of the inductor includes a wiring pattern of a meander shape.

7. A wireless communication apparatus including an antenna, the wireless communication apparatus comprising:
a first layer including a pattern so as to configure an inductor;
a second layer forming capacitance that is electrically coupled with inductance of the inductor; and
a third layer configuring an electric wall, the first layer being disposed between the third layer and the first layer.

8. The wireless communication apparatus according to claim 7, wherein
the inductor includes a structure including a plurality of unit elements smaller than a certain wavelength of electromagnetic waves, the inductor being formed by a left-handed metamaterial, permittivity and permeability of the left-handed metamaterial being negative.

9. The wireless communication apparatus according to claim 7, further comprising:
a fourth layer including a pattern for configuring an inductor; and
a fifth layer that is used to hold capacitance between the fifth layer and inductance of the inductor of the fourth layer.

10. The wireless communication apparatus according to claim 9, wherein
the inductor of the fourth layer includes a structure including a plurality of unit elements smaller than a certain wavelength of electromagnetic waves, the inductor of the fourth layer being formed by a left-handed metamaterial, permittivity and permeability of the left-handed metamaterial being negative.

11. The wireless communication apparatus according to claim 7, wherein
each of the plurality of unit elements includes a wiring pattern of a spiral shape.

12. The wireless communication apparatus according to claim 7, wherein
each of the plurality of unit elements of the inductor includes a wiring pattern of a meander shape.
